(19) United States
(12) Patent Application Publication
(10) Pub. No.: US 2006/0208186 A1
(43) Pub. Date: Sep. 21, 2006

(54) Nanospray ion source with multiple spray emitters

(76) Inventors: Paul C. Goodley, Cupertino, CA (US); Harvey D. Loucks JR., La Honda, CA (US); Michael J. Flanagan, Sunnyvale, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/081,325

(22) Filed: Mar. 15, 2005

(51) Int. Cl. H01J 49/10

(52) U.S. Cl. 250/288

(57) ABSTRACT

The present invention provides an apparatus and method for use with a mass spectrometer. The invention provides a mass spectrometer system for non-pneumatic ion production, including a non-pneumatic nanospray ionization source. The nanospray ionization source has a first non-pneumatic ion spray emitter for producing ions; a conduit adjacent to the ion spray emitter, the conduit having an aperture designed for receiving ions from the ion spray emitter; a first electrode for directing the ions from the ion spray emitter toward the aperture of the capillary; and a conduit electrode for directing ions into the conduit; and detector down stream from the capillary for detecting ions produced by the non-pneumatic nanospray ionization source. The invention also provides a non-pneumatic nanospray ionization source, comprising a first non-pneumatic ion spray emitter for producing ions; a conduit adjacent to the ion spray emitter, the conduit having an aperture designed for receiving ions from the ion spray emitter; a first electrode for directing ions from the ion spray emitter toward the aperture of the conduit and a conduit electrode for directing ions into the conduit. Also disclosed is a method for producing ions using a nanospray ionization source.

### BACKGROUND

Mass spectrometers work by ionizing molecules and then sorting and identifying the molecules based on their mass-to-charge (m/z) ratios. Two key components in this process include the ion source, which generates ions, and the mass analyzer, which sorts the ions. Several different types of ion sources are available for mass spectrometers. Each ion source has particular advantages and is suitable for use with different classes of compounds. Different types of mass analyzers are also used. Each has advantages and disadvantages depending upon the type of information needed.

Much of the advancement in liquid chromatography/mass spectrometry (LC/MS) over the last ten years has been in the development of new ion sources and techniques that ionize analyte molecules and separate the resulting ions from the mobile phase.

Previous approaches were successful only for a very limited number of compounds. The introduction of (atmospheric pressure ionization) API techniques greatly expanded the number of compounds that can be successfully analyzed using LC/MS. In this technique, analyte molecules are first ionized at atmospheric pressure. The analyte ions are then spatially and electrostatically separated from neutral molecules. Common API techniques include: electrospray ionization (ESI), atmospheric pressure chemical ionization (APCI), atmospheric pressure photoionization (APPI) and desorption ionization. Each of these techniques has particular advantages and disadvantages.

Electrospray ionization is a technique that relies in part on chemistry to generate analyte ions in solution before the analyte reaches the mass spectrometer. The liquid eluent is sprayed into a chamber at atmospheric pressure in the presence of a strong electrostatic field and heated drying gases. The electrostatic field charges the liquid eluent and the analyte molecules. The heated drying gas causes the solvent in the droplets to evaporate. As the droplets shrink, the charge concentration in the droplets increases. Eventually, the repulsive force between ions with like charges exceeds the cohesive forces and the ions are ejected (desorbed) into the gas phase. The ions are attracted to and pass through a capillary or sampling orifice into the mass analyzer. Some gas-phase reactions, mostly proton transfers and charge exchange, can also occur between the time ions are ejected from the droplets and the time they reach the mass analyzer.

Electrospray is particularly useful for analyzing large biomolecules such as proteins, oligonucleotides, peptides etc. The technique can also be useful for analyzing polar molecules such as benzodiazepines and sulfated conjugates. Other compounds that can be effectively analyzed include ionizing salts and organic dyes.

Large molecules often acquire more than one charge. Multiple charging provides the advantage of allowing analysis of molecules as large as 200,000 u even though the mass range (or more accurately mass-to-charge range) for a typical LC/MS instrument is around 3000 m/z. When a large molecule acquires many charges, a mathematical process called deconvolution may be used to determine the actual molecular weight of the analyte.

A second common technique performed at atmospheric pressure is atmospheric pressure chemical ionization (APCI). In APCI, the LC eluent is sprayed through a heated vaporizer (typically 250-400° C.) at atmospheric pressure. The heat vaporizes the liquid and the resulting gas phase solvent molecules are ionized by electrons created in a corona discharge. The solvent ions then transfer the charge to the analyte molecules through chemical reactions (chemical ionization). The analyte ions pass through a capillary or sampling orifice into the mass analyzer. APCI has a number of important advantages. The technique is applicable to a wide range of polar and nonpolar molecules. The technique rarely results in multiple charging like electrospray and is, therefore, particularly effective for use with molecules of less than 1500 u. For these reasons and the requirement of high temperatures, APCI is a less useful technique than electrospray in regards to large biomolecules that may be thermally unstable. APCI is used with normal-phase chromatography more often than electrospray is because the analytes are usually nonpolar and possess a high degree of hydrophobicity.

Atmospheric pressure photoionization for LC/MS is a relatively new technique. As in APCI, a vaporizer converts the LC eluent to the gas phase. A discharge lamp generates photons in a narrow range of ionization energies. The range of energies is carefully chosen to ionize as many analyte molecules as possible while minimizing the ionization of solvent molecules. The resulting ions pass through a capillary or sampling orifice into the mass analyzer. APPI is applicable to many of the same compounds that are typically analyzed by APCI. It shows particular promise in two applications, highly nonpolar compounds and low flow rates (<100 μl/min), where APCI sensitivity is sometimes reduced. In all cases, the nature of the analyte(s) and the separation conditions have a strong influence on which ionization technique: electrospray, APCI, or APPI will generate the best results. The most effective technique is not always easy to predict.

Each of these techniques described above ionizes molecules through a different mechanism. Unfortunately, none of these techniques are universal sample ion generators. While many times the lack of universal ionization could be seen as a potential advantage, it presents a serious disadvantage to the analyst responsible for rapid analysis of samples that are widely divergent. An analyst faced with very limited time and a broad array of numerous samples to analyze is interested in an ion source capable of ionizing as many kinds of samples as possible with a single technique and set of conditions. Unfortunately, such an API ion source technique has not been available.

Attempts have been made to improve sample ionization coverage by the use of rapid switching between positive and negative ion detection. Rapid positive/negative polarity switching results in an increase in the percentage of compounds detected by any API technique. However, it does not eliminate the need for more universal API ion generation. In addition, ion sources with multiple emitters have also been designed to improve the electrospray process. The problem with these devices is that they often require pneumatic assistance that can be costly.

More recently, advances have been made in being able to scale down the size of the emitters, chambers and capillaries to the nano level. For instance, nanospray devices have been developed for forming very small spray emissions that are efficient and highly effective. At this level and quantity there are very different properties effecting ion production and flow. However, to date such devices have been ineffective in efficiently separating charged droplets from other contaminating solvents, analytes or mobile phase molecules. At times these molecules can impact the final spectra and instrument sensitivity.

It, therefore, would be desirable to provide a source that does not require pneumatic assistance for nebulization production of aerosol. In addition, it would be desirable to provide an ion source that does not allow for recirculation of the ions that cause contamination of final spectra.

Thus, there is a need to provide an ion source that provides efficient ion collection with minimal production of contaminating species.

### SUMMARY OF THE INVENTION

A mass spectrometer system for non-pneumatic ion production, comprising a non-pneumatic nanospray ionization source, comprising a first non-pneumatic ion spray emitter for producing ions, a conduit adjacent to the ion spray emitter, the conduit having an aperture designed for receiving ions from the ion spray emitter; and a first electrode for directing the ions from the ion spray emitter toward the aperture of the conduit, and a conduit electrode for directing ions into the conduit; and a detector downstream from the conduit for detecting ions produced by the non-pneumatic nanospray ionization source.

The invention also provides a non-pneumatic nanospray ionization source, comprising a first non-pneumatic ion spray emitter for producing ions; a conduit adjacent to the ion spray emitter, the conduit having an aperture designed for receiving ions from the ion spray emitter, a first electrode for directing ions from the ion spray emitter toward the aperture of the capillary and a conduit electrode for directing ions into the conduit.

The invention also provides a method of producing and collecting ions in a non-pneumatic nanospray ion source. The method comprises producing ions from an ion spray emitter, producing a first electric field with an electrode to direct ions toward a conduit; and producing a second electric field with a conduit electrode to collect the ions in the conduit.

### BRIEF DESCRIPTION OF THE FIGURES

The invention is described in detail below with reference to the following figures:

FIG. 1 shows a general block diagram of a mass spectrometer system of the present invention.

FIG. 2 shows a general block diagram of a second mass spectrometry system.

FIG. 3 shows a side elevation of a first embodiment of the invention.

FIG. 4 shows a side elevation view with added field lines.

FIG. 5 shows a second embodiment of the present invention.

FIG. 6 shows a third embodiment of the present invention.

FIG. 7 shows a fourth embodiment of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “an emitter” includes more than one “emitter”. Reference to an “electrospray ionization source” or an “atmospheric pressure ionization source” includes more than one “electrospray ionization source” or “atmospheric pressure ionization source”. In describing and claiming the present invention, the following terminology will be used in accordance with the definitions set out below.

The term “adjacent” means near, next to or adjoining. Something adjacent may also be in contact with another component, surround (i.e. be concentric with) the other component, be spaced from the other component or contain a portion of the other component. For instance, an “emitter” that is adjacent to a electrode may be spaced next to the electrode, may contact the electrode, may surround or be surrounded by the electrode or a portion of the electrode, may contain the electrode or be contained by the electrode, may adjoin the electrode or may be near the electrode.

The term “atmospheric pressure ionization source” refers to the common term known in the art for producing ions. The term has further reference to ion sources that produce ions at ambient temperature and pressure ranges. Some typical ionization sources may include, but are not be limited to electrospray, APPI and APCI ion sources.

The term “charged droplet” or “charged droplet formation” refers to the production of molecules comprising a mixture of analyte, solvent and/or mobile phase.

The term “conduit” refers to any sleeve, capillary, transport device, dispenser, nozzle, hose, pipe, plate, pipette, port, orifice, orifice in a wall, connector, tube, coupling, container, housing, structure or apparatus that may be used to receive or transport ions or gas.

The term “conduit electrode” refers to an electrode that may be employed to direct ions into a conduit. The electrode may be used to collect ions in the conduit for further processing.

The term “corona needle” refers to any conduit, needle, object, or device that may be used to create a corona discharge.

The term “detector” refers to any device, apparatus, machine, component, or system that can detect an ion. Detectors may or may not include hardware and software. In a mass spectrometer the common detector includes and/or is coupled to a mass analyzer.

The term “electrospray ionization source” refers to a emitter and associated parts for producing electrospray ions. The emitter may or may not be at ground potential. Electrospray ionization is well known in the art.

The term “emitter” refers to any device known in the art that produces small droplets or an aerosol from a liquid.

The term “first electrode” refers to an electrode of any design or shape that may be employed for directing ions or for increasing or creating a field to aid in charged droplet formation or movement.

The term “second electrode” refers to an electrode of any design or shape that may be employed to direct ions or for increasing or creating a field to aid in charged droplet formation or movement.

The terms “first electric field”, “second electric field” and “third electric field” refer to contributions to the total electric field by individual electrodes as specified. The contribution to the electric field from a particular electrode is regarded as the field due to the charges on that electrode only (and the charges they induce on other electrodes). By the principle of superposition, the total electric field at any point is the sum of the contributions to the field at that point from all the electrodes present with the given applied voltages.

The term “ion source” or “source” refers to any source that produces analyte ions.

The term “ionization region” refers to an area between any ionization source and the conduit.

The term “molecular longitudinal axis” means the theoretical axis or line that can be drawn through the region having the greatest concentration of ions in the direction of the spray. The above term has been adopted because of the relationship of the molecular longitudinal axis to the axis of the conduit. In certain cases a longitudinal axis of an ion source or electrospray emitter may be offset from the longitudinal axis of the conduit (For example if the axes are orthogonal but not intersecting). The use of the term “molecular longitudinal axis” has been adopted to include those embodiments within the broad scope of the invention. To be orthogonal means to be aligned perpendicular to or at approximately a 90 degree angle. For instance, the “molecular longitudinal axis” may be orthogonal to the axis of a conduit. The term substantially orthogonal means 90 degrees±20 degrees. The invention, however, is not limited to those relationships and may comprise a variety of acute and obtuse angles defined between the “molecular longitudinal axis” and longitudinal axis of the conduit.

The term “nanospray ionization source” refers to an emitter and associated parts for producing ions. The emitter may or may not be at ground potential. The term should also be broadly construed to comprise an apparatus or device such as a tube with an electrode that can discharge charged particles that are similar or identical to those ions produced using nanospray ionization techniques well known in the art. Nanospray emitters at low liquid flow rates use flow rates ranging from 0.001×10⁻⁹ to 5000.0×10⁻⁹ L/Min. An emitter tip orifice ranges from 5.0×10⁻⁶ to 50.0×10⁻⁹ meters in diameter.

The term “pneumatic” refers to the use of gas flow assistance in charged droplet formation.

The term “non-pneumatic” refers to the production of charged droplet formation by some method other than gas flow assistance nebulization. For instance, electric or magnetic fields may be employed to aid in the formation of charged droplets from emitter(s).

The term “sequential” or “sequential alignment” refers to the use of ion sources in a consecutive arrangement. Ion sources follow one after the other. This may or may not be in a linear arrangement.

The invention is described with reference to the figures. The figures are not to scale, and in particular, certain dimensions may be exaggerated for clarity of presentation.

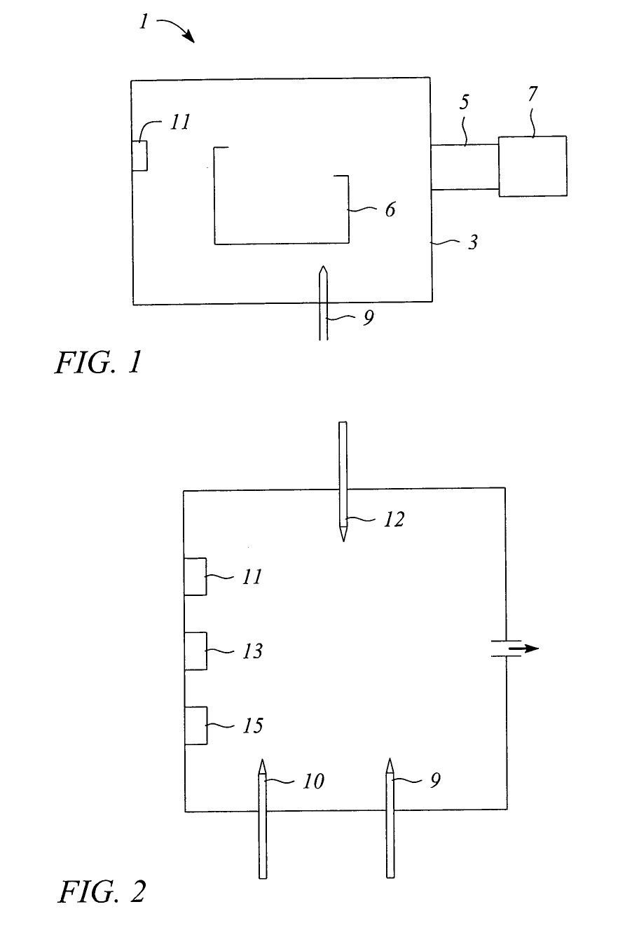

FIG. 1 shows a general block diagram of a mass spectrometry system of the present invention. The block diagram is not to scale and is drawn in a general format because the present invention may be used with a variety of different types of mass spectrometers and systems. The mass spectrometry system 1 of the present invention comprises an ion source 3, a transport system 5 and a detector 7. The invention in its broadest sense provides an ion source that produces a spectrum at low sample flow rates. The ion source 3 may comprise a variety of different types of sources that emit ions. For instance, a nanospray ion source with low sample flow rates. These ion sources may in certain instances be different from electrospray ion sources because of the differing physical and chemical properties at the nanoscale level and consequential differences in ion production mechanisms. In addition, often times the low flow rates used in nanospray do not require a gas assist in production of charged droplet formation. These low flow rates, therefore, allow for application of electric or magnetic fields in the formation and collection of charged droplets.

Referring now to FIGS. 1-2, the ion source 3 comprises a first emitter 9 and a first electrode 11 adjacent to the first emitter 9. The first emitter 9 and the first electrode 11 may be disposed anywhere in the ion source 3. FIG. 1 shows the option of having a housing 6 disposed in the ion source 3. The housing 6 may be designed similar to a Faraday cage or shield. In this design a single potential may be applied to the housing 6 so that it acts similar to an electrode. This electrode may then be used in charged droplet formation after the analyte has been emitted from one or more of the emitters. This is not a requirement of the system or ion source 3. Other housings, enclosures, electrodes, walls or devices may be employed that are known in the art.

FIG. 2 shows a second general block diagram of the invention. In this embodiment of the invention, additional electrodes and emitters are shown. For instance, the figure shows a first emitter 9, a second emitter 10, and a third ion emitter 12. Each of the ion emitters 9, 10 and 12 may be placed in various positions in and about the ion source 3. In addition, the figure shows the application of a variety of electrodes. For instance, the figure shows a first electrode 11, a second electrode 13 and a third electrode 15. The invention may comprise any number and combination of electrodes and emitters. Note the figure shows the first electrode 11, the second electrode 13 and the third electrode 15 are adjacent to each other. This is not a requirement of the invention. Each of the electrodes and emitters may be placed in various positions and orientations about the housing 6.

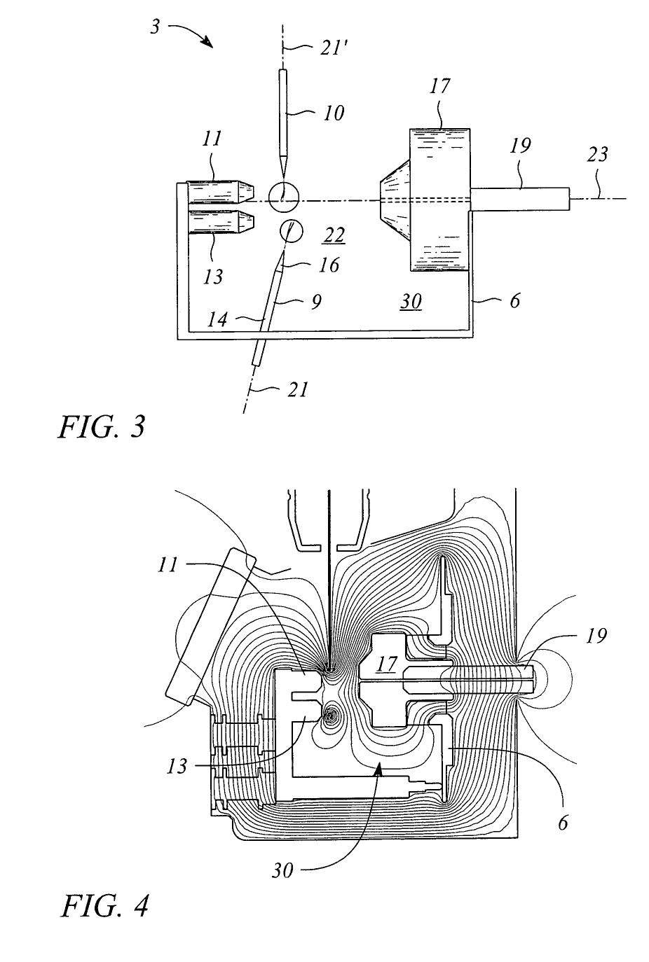

FIG. 3 shows a side elevation view of a portion of the present invention. The diagram is not to scale and is provided for illustration purposes only. FIG. 3 shows the ion source 3 in a nanospray configuration. The ion source 3 comprises the first electrode 11, the second electrode 13, the first emitter 9, the second emitter 10. Also displayed is a conduit electrode 17. The first electrode produces a first electric field for moving and directing ions. The conduit electrode 17 is designed for creating a second electric field that collects ions and directs them into transport system 5. Transport system 5 then directs the ions to the mass detector 7 (See FIGS. 1-3).

The first electrode 11, second electrode 13 and the conduit electrode 17 may be disposed in the housing 6. In other embodiments of the invention the first electrode 11, second electrode 13 and conduit electrode 17 may comprise the housing 6. In this embodiment of the invention a single potential is applied to the entire housing 6. The housing 6 may direct ions toward conduit 19 and/or shield ions from conduit 19. It should be noted that when housing 6 is operating like an electrode ions are ejected from the second emitter 10 where they travel toward the bottom of the housing 6. The spray becomes bifurcated due to the strong electric fields produced by the housing 6 or the combination of the conduit electrode 17 with the first electrode 11 and second electrode 13. The process provides overall improved production of charged droplet formation. In addition, the design and process separates gas phase ions from charged droplets that comprise solvent, analyte and/or mobile phase. This is accomplished by the fact that the gas phase ions are shed first from the spray that is emitted from the emitter. They can then be immediately collected, whereas the charged droplets travel in different directions from the conduit 19 or to the bottom of the housing 6 where they are not then collected by the conduit 19. This provides for a simple and effective process for collecting of gas phase ions without the other contaminating charged droplets that would lower overall instrument signal to noise ratio or sensitivity.

More than one emitter may be employed with the present invention. The first emitter 9, the second emitter 10 and the third ion emitter 12 may be disposed anywhere within the housing 6. Each emitter is designed so as to emit ions at low flow rates into the ion region 22. The emitter comprises a body portion 14 and an emitter tip 16. In FIG. 3 the first emitter 9 and the second emitter 10 are positioned opposite each other. They are also adjacent to the first electrode 11 and the second electrode 13. The conduit electrode 17 may comprise a portion of the conduit 19 or may be separate from the conduit. The conduit electrode 17 may have a variety of different tips. For instance, in certain instances the tip of the conduit electrode 17 may be blunt or pointed. In either case, the conduit electrode 17 may be designed to aid in the collection of ions into the conduit 19. The conduit electrode 17 is connected to a voltage source that is designed to create a third electric field (voltage source not shown in diagrams). The conduit electrode 17 creates a third electric field for drawing ions into the conduit 19 for detection by detector 7.

FIG. 3 shows the first electrode 11 and the second electrode 13 in an adjacent position disposed in the ion source 3. In FIG. 3 they are also positioned adjacent to the first emitter 9 and the second emitter 10 and opposite the conduit electrode 17. The figure only shows a pair of electrodes. However, a number or plurality of electrodes may be employed with the present invention.

FIG. 4 shows a side elevation with exemplary equipotential lines produced by the present invention. It should be noted that as the ions are emitted that flow from one or more emitter toward the conduit 19, they are aided by the fields produced by the first electrode 11, the second electrode 13 and the conduit electrode 17. Different potentials may be applied to each of the electrodes. However, when the first electrode 11 and the second electrode 13 are connected to the conduit electrode 17 a single housing is defined. A single potential can be applied to this single housing 6 to aid in the formation and collection of ions from one or more ion emitter. In addition, the housing 6 is designed in such a way that if the ions are not taken into the conduit 19, they pass out of the ionization region 22 (See FIGS. 3 and 4) and are collected on various positions on the conduit electrode 17 or circulated to position 30 and can not re-circulate to contaminate the aerosol. In certain instances, these are unwanted ions or ions of a particular mass to charge ratio that are not of interest to the user. This provides for improved overall sensitivity of the device.

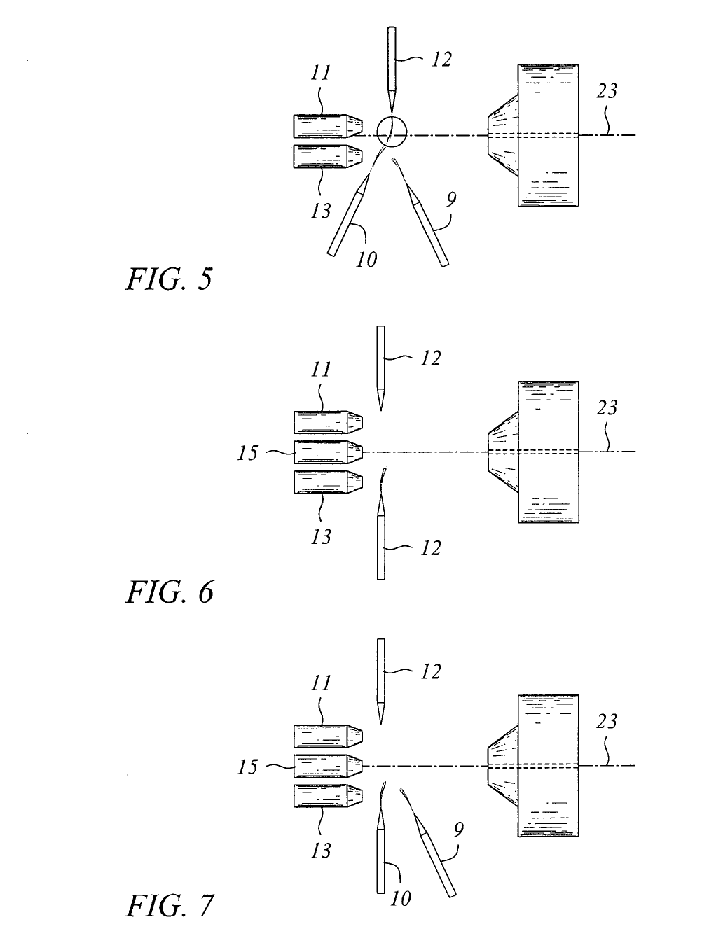

FIGS. 5-7 show various embodiments of the present invention. In particular, the emitters and electrodes are displayed in various positions and orientations. Various numbers of electrodes may also be employed with the present invention.

Referring now to FIGS. 1-6, a description of more detail regarding the components may be necessary.

The first electrode 11 may comprise any number of materials and components. For instance, the electrode 11 may comprise a metallic material commonly used by electrodes such as gallium, titanium nitride, vanadium, chromium, nickel, copper, zinc, cobalt, cesium, germanium, gold, iron, lead, iridium, indium, platinum, tin, silver, silicon or combinations or alloys of these materials. The electrode may comprise any number of shapes and sizes that are conducive in producing an electric field for directing ions. The size, magnitude and position of the electric field may also be changed or designed as one who is skilled in the art desires. The first electrode 11 is designed for producing the first electric field. This field is designed for directing ions toward the conduit electrode 17. It this design a similar or different potential may be applied to the electrode relative to the other electrodes used in the ion source 3.

The second electrode 13 and other disclosed electrodes that may not be portrayed in the diagrams may also comprise any number of materials and components. For instance, the second electrode 13 may comprise a metallic material commonly used by electrodes such as gallium, titanium nitride, vanadium, chromium, nickel, copper, zinc, cobalt, cesium, germanium, gold, iron, lead, iridium, indium, platinum, tin, silver, silicon or combinations or alloys of these materials. The electrode may comprise any number of shapes and sizes that are conducive in producing an electric field for directing ions. The size, magnitude and position of the electric field may also be changed or designed as one who is skilled in the art desires. The second electrode 13 is designed for producing a second electric field. This field is also designed for directing ions toward the conduit electrode 17. As discussed before, this electrode may have the same potential applied to it as first electrode 11 or a different potential from this electrode and the other electrodes. In the case that the electrode comprises a portion of the housing 6 a single potential may be applied to the entire housing to act as a single electrode.

It should be noted that it is the positioning, orientation and combination of the first electric field produced by the first electrode 11 and the second electric field produced by the second electrode 13 that direct ions in the direction of the conduit electrode 17. The equipotentials corresponding to the total electric field are shown in FIG. 4. As discussed it is possible that the housing 6 may be employed as a single electrode to create, separate and collect ions.

The first emitter 9 and the second emitter 13 may comprise a body portion 14 and a tip 16. The body portion 14 and the tip 16 may comprise similar or different materials. They also may comprise various materials that are known in the art for the production of ions. Such materials may comprise hydrophobic or other similar materials. They may comprise these materials or be coated with such materials. Other shapes and designs of the electrodes are within the scope of the invention. The emitters may be designed for producing ions at low flow rates. These flow rates are effective for use with the electrodes of the present invention. The emitters may comprise a variety of materials and shapes known and described in the art. For instance, the emitters may comprise materials such as metal, plastics, polycarbonate, etc. It is the low flow rates of the liquids from the emitters combined with the fields that allow for the production, separation and collection of the ions. In the diagram, each of the emitters 9 and 13 comprise a molecular longitudinal axis 21 and 21′ along which the ions are ejected.

The conduit electrode 17 may comprise a portion of the conduit 19. The conduit electrode 17 is designed for producing a third electric field as shown in the diagram. In addition, the conduit electrode 17 may be designed to be thermally conductive to provide heating into the ionization region 20. The conduit 19 has a central axis 23 that runs along the length of the electrode and through conduit electrode 17. Lastly, other conduits similar to conduit 19 may be employed with the present invention. For instance, other conduits may be placed anywhere throughout the housing 6 or ion source 3 to collect ions that are formed.

Referring now to FIGS. 4-6, the emitters and electrode may be positioned in a number of orientations and locations relative to the conduit 19. For instance, the molecular axis 21 or 21′ of the first emitter 9 or second emitter 13 may be positioned in various angles relative to the central axis 23 of the conduit 19. Some angles may comprise from 0 to 10 degrees, from 10 to 30 degrees, from 30 to 90 degrees, from 90 to 180 degrees and from 180 to 360 degrees. In certain embodiments, the molecular axis 21 of the first emitter 9, or molecular axis 21′ of the second emitter 13 (or other emitters), may be positioned orthogonal to the central axis 23 of the conduit 19. FIG. 3 shows the second emitter 13 in orthogonal arrangement to the central axis 23 of the conduit 19.

Having described the apparatus of the present invention, a description of the method of the invention is now in order. Referring now to FIG. 3, the method of the present invention is most clearly illustrated. The first electrode 11 and the second electrode 13 are electrically connected to one or more voltage sources (not shown in the picture). The voltage source creates electric fields about the electrodes for directing ions. The same or a different voltage source may be electrically connected to each electrode.

The first electrode 11 is positioned and designed for creating a first electric field. The potentials can be seen in the diagram and direct ions in a defined direction. For instance, ions in the diagram are produced from the first emitter 9 and/or the second emitter 13 and are directed toward the conduit 19 by the first electrode 11 and the conduit electrode 17.

The second electrode 13 creates a second electric field similar to the electric field around the first electrode 11. In each case, the ions that are produced from the first emitter 9 and the second emitter 10 are designed to be drawn toward the inlet electrode 17 and the aperture of the conduit 19 (not shown in the FIG. 4). For instance, an ion is produced from the first emitter 9 or the second emitter 10. The electric fields then draw the ions toward the conduit electrode 17. The conduit electrode 17 produces a third electric field that draws the ions into the conduit 19. If an ion is not drawn into the conduit 19 it escapes and passes to a region 30 outside the housing 6. The housing 6 prevents unwanted ions from re-circulating back into the electric fields that direct the desired ions toward the conduit 19 for collection and then detection by the detector 7.

It is the positioning of the electrodes, emitters and conduit electrodes, and flow rates of ions from the emitters that influence the production and ion collection process. Since these components are in close proximity and flow rates are low, it is not required to use gas or gas flow assistance nebulization. In other words, a non-pneumatic system is produced that provides for very efficient production, separation and collection of ions. No other components, gas inlet ports etc. are required. It is to be understood that while the invention has been described in conjunction with the specific embodiments thereof, that the foregoing description as well as the examples that follow are intended to illustrate and not limit the scope of the invention. Other aspects, advantages and modifications within the scope of the invention will be apparent to those skilled in the art to which the invention pertains.

All patents, patent applications, and publications infra and supra mentioned herein are hereby incorporated by reference in their entireties.

We claim:

1. A non-pneumatic nanospray ionization source, comprising:
(a) a first ion spray emitter for producing ions;
(b) a conduit adjacent to the first ion spray emitter, the conduit having an aperture designed for receiving ions from the first ion spray emitter; and
(c) a first electrode adjacent the conduit for directing ions from the ion spray emitter toward the aperture of the capillary; and
(d) a conduit electrode for directing ions into the conduit.

2. A non-pneumatic nanospray ionization source as recited in claim 1, further comprising a second ion spray emitter adjacent to the first ion spray emitter.

3. A non-pneumatic nanospray ionization source as recited in claim 1, further comprising a second electrode adjacent to the first electrode.

4. A non-pneumatic nanospray ionization source as recited in claim 1, wherein the first ion spray emitter comprises a molecular axis.

5. A non-pneumatic nanospray ionization source as recited in claim 1, wherein the conduit comprises a central longitudinal axis.

6. A non-pneumatic nanospray ionization source as recited in claim 4, wherein the conduit comprises a central longitudinal axis.

7. A non-pneumatic nanospray ionization source as recited in claim 6, wherein the molecular axis of the first ion spray emitter is orthogonal in arrangement to the central longitudinal axis of the conduit.

8. A non-pneumatic nanospray ionization source as recited in claim 6, wherein the molecular axis of the first ion spray emitter is in substantial orthogonal arrangement to the central longitudinal axis of the conduit.

9. A non-pneumatic nanospray ionization source as recited in claim 6, wherein the molecular axis of the first ion spray emitter is at an angle of from 10 to 30 degrees from the central longitudinal axis of the conduit.

10. A non-pneumatic nanospray ionization source as recited in claim 6, wherein the molecular axis of the first ion spray emitter is at an angle of from 30 to 60 degrees from the central longitudinal axis of the conduit.

11. A non-pneumatic nanospray ionization source as recited in claim 6, wherein the molecular axis of the first ion spray emitter is at an angle of from 60 to 90 degrees from the central longitudinal axis of the conduit.

12. A non-pneumatic nanospray ionization source as recited in claim 6, wherein the molecular axis of the first ion spray emitter is at an angle of from 90 to 180 degrees from the central longitudinal axis of the conduit.

13. A non-pneumatic nanospray ionization source as recited in claim 6, wherein the molecular axis of the first ion spray emitter is at an angle of from 180 to 360 degrees from the central longitudinal axis of the conduit.

14. A non-pneumatic nanospray ionization source as recited in claim 6, wherein the molecular axis of the first ion spray emitter is at an angle of from 0 to 360 degrees from the central longitudinal axis of the conduit.

15. A non-pneumatic nanospray ionization source as recited in claim 1, wherein said nanospray ionization source is maintained at a pressure in the range of from 10 Torr to 2000 Torr.

16. A mass spectrometer system for non-pneumatic ion production, comprising:
(a) a non-pneumatic nanospray ionization source, comprising:
(i) a first ion spray emitter for producing ions;
(ii) a conduit adjacent to the first ion spray emitter, the conduit having an aperture designed for receiving ions from the ion spray emitter; and
(iii) a first electrode for directing the ions from the ion spray emitter toward the conduit; and
(iv) a conduit electrode for directing ions into the conduit; and
(b) a detector downstream from the capillary for detecting ion produced by the non-pneumatic nanospray ionization source.

17. A non-pneumatic nanospray ionization source as recited in claim 16, further comprising a second ion spray emitter adjacent to the first ion spray emitter.

18. A non-pneumatic nanospray ionization source as recited in claim 16, further comprising a second electrode adjacent to the first electrode.

19. A non-pneumatic nanospray ionization source as recited in claim 16, wherein the first ion spray emitter further comprises a molecular axis.

20. A non-pneumatic nanospray ionization source as recited in claim 16, wherein the conduit electrode comprises a central longitudinal axis.

21. A non-pneumatic nanospray ionization source as recited in claim 20, wherein the conduit electrode comprises a central longitudinal axis.

22. A non-pneumatic nanospray ionization source as recited in claim 21, wherein the molecular axis of the first ion spray emitter is orthogonal in arrangement to the central longitudinal axis of the conduit.

23. A non-pneumatic nanospray ionization source as recited in claim 22, wherein the molecular axis of the first ion spray emitter is in substantial orthogonal arrangement to the central longitudinal axis of the conduit.

24. A non-pneumatic nanospray ionization source as recited in claim 22, wherein the molecular axis of the first ion spray emitter is at an angle of from 10 to 30 degrees from the central longitudinal axis of the conduit.

25. A non-pneumatic nanospray ionization source as recited in claim 22, wherein the molecular axis of the first ion spray emitter is at an angle of from 30 to 60 degrees from the central longitudinal axis of the conduit.

26. A non-pneumatic nanospray ionization source as recited in claim 22, wherein the molecular axis of the first ion spray emitter is at an angle of from 60 to 90 degrees from the central longitudinal axis of the conduit.

27. A non-pneumatic nanospray ionization source as recited in claim 22, wherein the molecular axis of the first ion spray emitter is at an angle of from 90 to 180 degrees from the central longitudinal axis of the conduit.

28. A non-pneumatic nanospray ionization source as recited in claim 22, wherein the molecular axis of the first ion spray emitter is at an angle of from 180 to 360 degrees from the central longitudinal axis of the conduit.

29. A non-pneumatic nanospray ionization source as recited in claim 22, wherein the molecular axis of the first ion spray emitter is at an angle of from 0 to 360 degrees from the central longitudinal axis of the conduit.

30. A non-pneumatic nanospray ionization source as recited in claim 16, wherein said nanospray ionization source is maintained at a pressure in the range of from 10 Torr to 2000 Torr.

31. A non-pneumatic nanospray ionization source, comprising:
(a) a first ion spray emitter for producing ions;
(b) a housing for directing ions; and
(c) a conduit for receiving ions produced and directed by the housing.

32. A non-pneumatic nanospray ionization source, as recited in claim 31, wherein a single potential is applied to the housing.

33. A method for producing ions, in a non-pneumatic nanospray ion source, comprising:
(a) producing ions from a nanospray emitter;
(b) producing a first electric field with a electrode to direct ions toward a conduit; and
(c) producing a second electric field with a conduit electrode to collect ions into the conduit.
